(19) United States
(12) Patent Application Publication
(10) Pub. No.: US 2006/0249330 A1
(43) Pub. Date: Nov. 9, 2006

(54) Pod with lockable, extendable arms

(76) Inventor: Jean-Francois Tardy, Courbevoie (FR)

Correspondence Address: BIRCH STEWART KOLASCH & BIRCH, PO BOX 747, FALLS CHURCH, VA, 22040-0747, US

(21) Appl. No.: 10/563,835

(22) PCT Filed: Jul. 7, 2004
(86) PCT No.: PCT/FR04/01765

§ 371 Date: Jun. 27, 2006

(30) Foreign Application Priority Data
Jul. 9, 2003 (FR) 03/08402

(51) Int. Cl. E04G 3/28; B64C 1/22

(52) U.S. Cl. 182/142; 244/137.2

(57) ABSTRACT

The pod comprises a central mast (1, 8), a support section (9) of which bears ends of arms (30) pivotally mounted so that respective opposed free sections (32) are, in a position folded back against the mast (1, 8), maintained by a removable locking device comprising an axially movable crown member (10) for radially locking the arms (30), the crown member (10) being held in locking position through a hysteresis effect in which the crown member (10) can be driven, through the expansion of a loaded spring (20), in a movement of recoil from its locking condition, only after additional loading of the spring (20) by an external force in order to release a mobile stop (21), for inhibiting the action of the spring (20), held in precarious anti-recoil stop equilibrium by the crown member (10).

The invention relates to a basket, or pod, comprising a mast, for suspension by a rope or cable, bearing horizontally deployable arms for evacuating persons urgently.

The problem at the root of the invention, but which must not limit the scope of the present application, related to a pod suspended at the end of a cable beneath a helicopter to enable persons in danger to take refuge therein in order to be evacuated rapidly, for example in the event of flooding, or disturbances. The pod has the overall shape of an inverted umbrella which has to remain folded back while being transported in the helicopter, for reasons of available space, as well as during its descent, to prevent it from being blown off course by the wind. The arms are held folded back against the central mast by a mechanism including a solid sliding ring for deploying the arms, fastened to the mast by a mechanism equipped with springs radially pushing ball domes along a circular groove in the mast. When the unwinding of the cable is abruptly halted, the solid ring exerts an axial force exceeding the force threshold of the springs and thus extracting the balls from the groove, so that the ring slides and controls the deployment of the arms.

Such a mechanism does, indeed, function correctly. However, the present invention does not contemplate the need for a sliding ring to control deployment of the arms, that is to say the arms may be pivotal only, without necessarily being deployed by a sliding mechanism.

The present invention thus aims to provide another solution for removably locking the arms in the folded back position.

For this purpose, the invention provides a pod for evacuating persons, including a central mast, a support section of which bears ends of arms pivotally mounted so that respective opposed free sections are, in a folded back position substantially axial in relation to an axis of the mast, maintained by a removable locking device, characterised by the fact that the locking device comprises an axially movable crown member disposed at an axial distance from the support section, to radially maintain the arms in a locking hold condition, the crown member being held in a locking position through a hysteresis effect in which the crown member can be driven, through the unloading of a loaded spring one end of which occupies a counter-pressure position axially fixed in relation to the mast, in a movement of recoil from its locking hold condition, only after additional loading of the spring by an external force in order to release a mobile stop member, for inhibiting the action of the spring, held in precarious anti-recoil stop equilibrium by the crown member.

Thus, manual pressure on the crown member enables the arms to be deployed. The force of this pressure must exceed a threshold, corresponding to the force of the spring in the loaded state.

The terms <<free sections>> denote any part of the arms, other than the pivoting end which is axially fixed, that is to say any section of the rest of the arms that is capable of the deployment movement, and the radial blocking of which locks the arm in the folded back position. Indeed, as explained below, the arms can be released by simple axial sliding of the crown member out of the axial zone that they occupy along the axis of the mast, and it is then their free ends that are preferably under locking hold condition, or else released by sliding with rotation of the crown member causing lateral release, and no longer axial release, of the arms through the recoil in rotation of locking tabs or hooks disposed on the periphery of the crown member.

It will be noted, as mentioned or explained hereinafter, that, since the device necessitates two axial counter-pressure, or counter-bearing, members, for the spring and the opposed stop member, respectively, these counter-pressure members can be provided by lateral relief portions, salient or hollow, on the mast and/or one or more arms, since the folded back arms each form the equivalent of a mast with an axial position that is fixed in relation to the central mast. In other words, the spring and/or the stop member can each, independently of one another, take up an axial counter-pressure by bearing on a lateral relief portion on the mast or on a lateral relief portion on a given arm. Thus, when the two counter-pressures are exerted on the same arm or on two arms, the mast can be only made of an arm hinging section, with the arms cooperating exclusively with one another to lock into the folded back position.

In the functional position, suspended from the pod, the arms can be folded back upwards, so as to be able to deploy through the gravity effect, or folded back downwards, with return springs, preferably, in this case, to cause them to move up into the deployed position, and means for locking each arm in the deployed position. If it is the downward folded back position that is chosen, it will be noted that, as explained above, the mast will comprise, preferably, only said arm hinging section rotationally supporting the arms, in order to enable the deployed arms to be placed finally on the ground.

The crown member can then be mounted slidably, tightly or otherwise, depending on the particular design mechanism of the device, on an opposed section of the mast or on a section of a particular one of the arms. In the latter case, the spring can be arranged so that its counter-pressure is exerted on a lateral relief portion of the particular arm, although a counter-pressure/bearing on another arm or on the mast is not to be ruled out.

Similarly, the stop member can be arranged to take up a counter-pressure/bearing on a lateral relief portion of one of the arms.

To facilitate the release of the crown member, there are preferably provided means for driving the stop out of its position of precarious equilibrium, for example a spring for drawing the stop back out of its precarious equilibrium position, or, alternatively, a link fixed to the crown member, that is to say pulling on the stop member and putting it off balance when the crown member moves away from the stop member under the effect of the external force.

Alternatively, the stop member driving means can comprise a ramp of the crown member, partially extending radially in relation to the mast, engaging with an opposed ramp on the stop member, to radially push back the stop out of its position of precarious equilibrium, when the crown member moves away from the stop member when the spring is additionally loaded.

The crown member thus comprises a sort of rostrum or spur curved to form a C or an L opening to form a ramp, one end of which engages with the stop member, of the same shape, but inverted, to thus laterally push the stop member back when the crown member moves away therefrom.

The crown member can comprise an axial relief portion for maintaining the stop member in precarious equilibrium, for example a rib or a groove forming a shoulder.

To prevent the stop member being lost, and in order to better control its movement, the stop member can be mounted so as to be movable on the mast, or on the crown member, in translation or pivotally.

In the latter case, the stop member is preferably associated with a member, limiting a pivoting range, and defining the position of precarious equilibrium. This can be a rotation range limiting member located at the joint of the stop member, or a member cooperating with the free end of the stop member and belonging to the crown member, or else to the mast.

It can also be another stop member, that is to say the stop member then has a movement of travel intersecting, in the position of precarious equilibrium, that of another stop forming the pivoting range limiting member.

The two or more stop members can thus press up against one another, forming a triangle or bundle. The other stop member thus serves to brace the spring inhibiting stop member, and said other stop member may possibly also serve as a spring inhibiting stop member, with the two stop members then having, for example, the same shape. It will be noted, however, that the two stop members can present, to the crown member, two respective remote points of abutment, that is to say points other than their mutual abutment point. This is, for example, the case of C-shaped stop members, hinged at one end and coming to bear on one another, back to back.

The stop member can be mounted so as to pivot elastically about an axis substantially parallel to a sliding direction of the crown member so as said stop member to be drawn back, out of the position of precarious equilibrium, into an angular sector affording it free axial passage.

The stop member can function in compression, that is to say be disposed on the crown member travel side, away from the arm supporting section, or else be disposed on the arm supporting section side, in order to work in traction, and the stop member then has a retaining hook having an inner surface of abutment cooperating with a retaining relief portion of the crown member, for example a cavity with a hook shaped section, opening radially or away from the arm supporting section.

It is not necessary for the stop member, once off balance, to take up a position outside the travel path of the crown member. The stop member can, in fact, assume the form of a cam, arranged for, when the stop member is out of the position, or condition, of precarious equilibrium, being driven by the crown member away from the recoil travel path of the latter.

Preferably, to avoid twisting stress, there is provided a plurality of stop members distributed equally about the mast.

In order for the arms to open automatically, the crown member can have a determined mass to effect the additional loading of the spring in the event of a deceleration threshold being exceeded.

Abrupt deceleration of the device in the desired axial direction, for example through a sudden halt in the unwinding of a suspension cable, temporarily loads the spring even further to thus release the stop member opposed to its action, and thus enable the spring to cause the crown member to recoil so as to release the arms.

In exactly the same way as the stop member, and regardless of the form of embodiment thereof, the spring can work in compression or traction.

As it is a case of maintaining a discrete number of arms, the crown member can be formed of a ring, serving for slidable guidance, bearing hooks or tabs for holding free sections of the respective arms.

In such a case, the mast can be externally threaded over a recoil travel section on which the crown member recoils, said externally threaded section cooperating with an internal thread of the crown member so as to angularly offset, in the recoil travel movement, sectors, of the tabs, arranged for causing said locking hold condition, said offset being in relation to fixed sectors occupied by the free sections of the arms.

It will be noted that then, the release of the arms takes place laterally hereto, and not endwise as in the case of simple sliding, that is to say the crown member does not necessarily have to slide beyond the free ends of the arms, since it can remain, in unlocked position, axially in the area of the arms.

Preferably, the crown member is arranged to cooperate with a safety mechanism provided for holding the crown member in the arm locking position.

For this purpose, the mast can have a non-circular cross-section fitted to a shape corresponding sliding member, for instance a sleeve, for axial sliding of the crown member, to angularly index the crown member, with the mast having, in the area of the position of the crown member locking the arms, a section with a non-fitted cross-section delimiting a circumferential lateral passage accessible to the sliding member through rotation of the crown member by an operator and having two axially opposed shoulders for holding the crown member in the axial arm locking position.

Again for this purpose, alternatively, the crown member belongs to a head of the mast comprising a slide means of the safety mechanism, movable in a radial plane of the mast to cooperate with at least one shoulder facing the crown member in order to axially block the crown member in at least one sliding direction.

The invention will be more readily understood with the help of the following description of a form of embodiment of a basket, or pod, having a removable locking device according to the invention, with reference to the attached drawings, wherein:

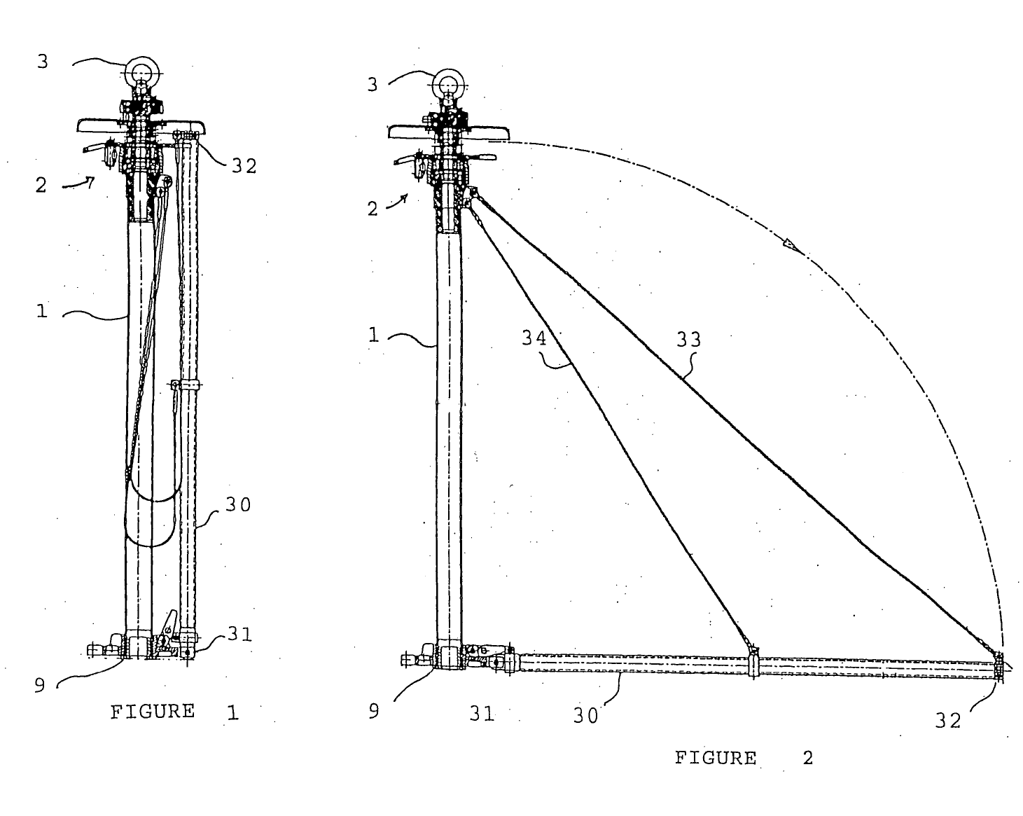

FIG. 1 is a side view of a rescue pod in folded back position, comprising a locking device, according to the invention;

FIG. 2 is a side view of the rescue pod in deployed position;

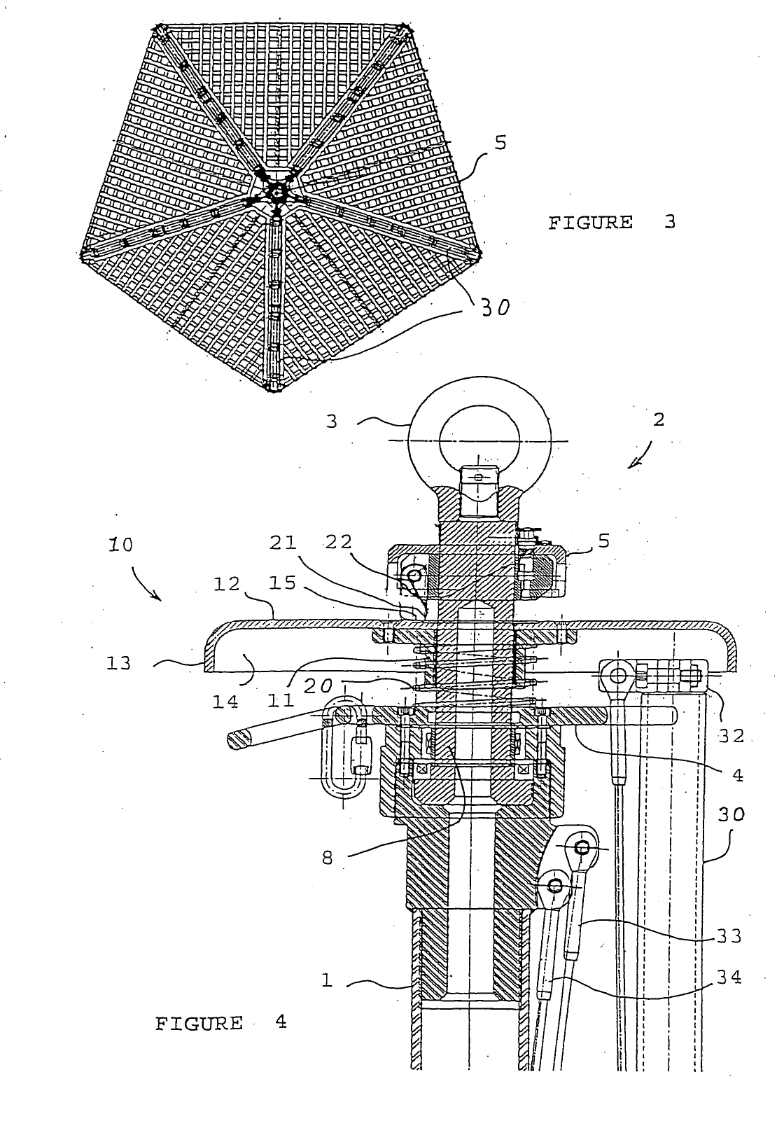

FIG. 3 is a top view of the pod; and

FIG. 4 is an enlarged side view of the locking device.

The rescue pod shown is designed to evacuate persons in danger quickly. As shown in FIGS. 1 and 2, the pod is conventionally transported folded back, according to FIG. 1, in a helicopter, and it is dropped, fixed to a rope or cable by a ring 3 integral with a head 2 of a mast with a central axis 1, vertical in the functional position. The pod comprises a plurality, five here, of identical arms 30, only one of which is shown in FIGS. 1 and 2, for the sake of clarity, all of them being shown in FIG. 3. Each arm 30 hinges at one end, 31, at a heel 9 of mast 1, so that each is able to pivot in a plane, axial to mast 1, and radial in a specific direction, precisely here in equally distributed radial directions, hence spaced apart by 72 degrees. Heel 9 is a sort of ring fitted over mast 1 and axially fixed in this example.

To facilitate the explanation, the pod is shown in its vertical, functional orientation. The explanations can, of course, be transposed to suit another orientation.

Each arm 30 can thus deploy through the effect of gravity and, possibly, the action of springs, not shown, located, for example, at the hinges of ends 31.

Head 2 is connected to a free section end 32 of arm 30 by a outer guy wire 33 and connected at an intermediate point on arm 30, by an inner guy wire 34, so that arm 30 extends perfectly radially in relation to the horizontal in the deployed position. The orientated quadrant shown in dotted lines in FIG. 2 illustrates the path of deployment of a free section 32.

As shown in FIG. 3, arms 30 bear a strong netting or web 5, for receiving persons.

FIG. 4 provides a more detailed view of head 2, comprising the arm 30 locking device. The locking device comprises a crown member 10, here in the arm 30 locking position, mounted to slide to and from over mast 1 by being integral with a sliding guiding member 11, here a ring or sleeve, for sliding guidance, fitted to a diameter value of mast 1. Crown member 10 has here a mushroom shape, with the guide sleeve 11 taking the form of a cylindrical section sliding over a rod 8 prolonging mast 1 in head 2, sleeve 11 being continued by an inverted cupel formed by a central part 12 substantially forming a radial disk and an outer rim 13 descending towards heel 9. Mast 1 and rod 8 have, here, a circular cross-section. However, alternatively, instead of being a sleeve, sliding guiding member 11 can comprise one or more slide members of an overall dovetail shape, introduced into one or more respective longitudinal grooves, having edges narrowing towards each other, on rod 8.

A space 14, radially internal in relation to rim 13, receives the free sections 32 of arms 30 in the folded back position with, however, a margin of axial play, here of a few millimetres, in relation to the lower face of disk 12. Rim 13 thus has, radially, a hold control coverage over a certain axial length to lock arms 30 in folded back position as long as the free edge of rim 13 is located at a level below the apices of the ends of free sections 32 of arms 30.

Crown member 10 is biased upwards, hence away from heel 9 and arms 30, by a return spring 20, which is helicoidal here, and wound so as to be centred on rod 8, as a central main return spring. Return spring 20, which works here in expansion starting from a compressed, loaded state, bears on a lower ring 4, which is axially fixed, of head 2, to push crown member 10 back upwards by bearing on a radial downward facing shoulder of the sliding guidance sleeve 11.

An upper part of head 2, above crown member 10, comprises an assembly having an overall ring shape, with a fixed axial position opposed to ring 4. From its locked position shown, crown member 10 can, as indicated, slide axially in both directions between ring 4 and ring 5, thanks, respectively, to the play, i.e. gap, in relation to the ends of free sections 32 of arms 30 and to an upward recoil travel play, corresponding to at least the axial length of the captive end sections 32 of arms 30.

However, a removable stop member 21, wedged, i.e. blocked, in a position of precarious equilibrium between upper ring 5 and crown member 10, prevents crown member 10 from moving back upwards through the action of return spring 20. Stop member 21 is, here, a sort of finger pivotally mounted under ring 5 to occupy a position of axial extension located in the ascending recoil travel path space of crown member 10, to thus serve as a spacer inhibiting the action of return spring 20. In this example, a return spring 22, here of a filiform shape, tends to return stop member 21 to an at least inclined position on the axis of mast 1, so that central disk 12 completely pushes it back in rotation upwards under the action of central spring 20.

Stop member 21 then performs the function of a cam pushed back in rotation by radial disk 12 by sliding thereover, here radially outwards, owing to the fact that stop member 21 then abuts obliquely on disk 12. Preferably, however, as here, filiform shaped spring 22 itself returns stop member 21 to a substantially radial non-functional, unloaded, position outside the space, of upward recoil travel path of crown member 10, necessary to release arms 30.

Stop member 21 is maintained here in a axial functional position of precarious equilibrium by a shoulder 15, facing towards the axis of mast 1 and of a limited axial height, limiting, in this example, a central cavity of the upper face of disk 12.

Alternatively, stop member 21 could occupy an oblique precarious position, by bearing on the edge of rod 8, that is to say a position reached by a circular loading, or enabling, path, i.e. for accessing a functional position, in a radial plane of rod 8, from the substantially radial non-functional position, a loading path in which the displacement of the free end of stop member 21 has a movement component of axial approach towards crown member 10, and then an opposed movement component, of axial re-ascending withdrawal after passing through the purely axial lower extended position of FIG. 4. As a result, disk 12 can then be perfectly planar, that is to say without shoulder 15, since the release of stop member 21 necessitates, in this alternative embodiment, a downward recoil of crown member 10, while main return spring 20 opposes this recoil by providing a force, of upward bias, greater than the descending axial component of the force exerted by return spring 22 associated with stop member 21.

The operation of the device will now be explained in greater detail.

To release arms 30, crown member 10 first has to be pressed down towards them to release the free end of stop member 21 so that it is at an axial distance from the top of shoulder 15, that is to say outside the corresponding cavity. The filiform return spring 22 can then return stop member 21 to the substantially radial folded back position, outside the ascending recoil travel path movement desired for crown member 10. Inhibition of the action of central main return spring 20 being thus removed, the latter pushes crown member 10 back upwards, which enables arms 30 to deploy under the effect of gravity or with the help of springs.

The pressing down with axial sliding of crown member 10 is effected manually, or through an effect of inertia, by ensuring that crown member 10 has sufficient mass to temporarily crush, that is to say to load somewhat more, main return spring 20, in the event of axial deceleration through the effect of a sudden halt in the descent of the suspension cable.

Alternatively, the withdrawal of the stop member (21) can be effected by rotation about an axis substantially parallel to that of mast 1, so that associated return spring 22 returns stop member (21) into an angular rest sector corresponding to a slit or a passage provided axially in disk 12. The stop member (21) can thus, for example, be an elastic finger laterally inserted into rod 8, with a free end being inclined towards disk 12. To place stop member (21) in a position of precarious equilibrium, the stop member (21) is then pushed back angularly by an operator to axially place its free end, pivoting in a plane substantially purely radial of mast 1, in front of a cavity in disk 12, said disk 12 having been then recoiled against the action of return spring 20, the cavity having a shoulder similar to shoulder 15 but with radial extension. Release of crown member 10 by the operator causes the free end of the stop member (21) to be captured laterally in the axially facing cavity, hence the maintaining in abutment in the position for inhibiting the action of return spring 20. Downward axial pressure on crown member 10 releases the stop member (21), which returns elastically into its angular rest sector, for which the stop member (21) has, at its disposal, a completely free axial passage through crown member 10.

Dually, the stop member (21) can be mounted pivotally on crown member 10 to form a support leg abutting, in precarious equilibrium, on the bottom of a cavity in head 2, said cavity being, for example, directly hollowed out in rod 8. When it emerges from said cavity internal to the cross-section of rod 8, the free end of the stop member (21) can then slide axially against or at a distance from the lateral surface of rod 8, said passage then being formed by the space external to rod 8.

There can further be provided a safety mechanism to prevent unexpected unlocking. The safety mechanism aims to block axial translation of crown member 10, and the corresponding blocking effect can be accomplished by blocking any upward translation, or by similar downward blocking to prevent the release of stop member 21, or, better still, by complete axial blocking, hence without, respectively, the risk of undetected release of stop member 21 or the risk of failure during storage of stop member 21 and an associated mecanism.

The safety mechanism can consist of a rigid finger arranged for being inserted between two axially facing shoulders blocking any axial translation of said safety mecanism. The finger and the two shoulders are integral with a given respective support member in the group of supports formed by mast 1/rod 8 and crown member 10. The finger or the two shoulders is/are mounted so as to be movable in translation or, preferably, in rotation, in a plane substantially radial to the axis of mast 1 in order to come into mutual safety locking position engagement of crown member 10 and to disengage mutually in order to axially release crown member 10.

Thus, for example, the radial surface of the lower end of sliding sleeve 11 can bear such a rotary finger that lodges in a cavity in rod 8 forming said two shoulders. Dually, rod 8 can comprise a deployable finger lodging in a slit in sliding sleeve 11. It can further be provided for the mast 1, more exactly rod 8, to be of a shape other than a perfectly circular one, so that sliding sleeve 11 can slide only when crown member 10 occupies a particular angular position in relation to rod 8.

In such a case, rod 8 and the corresponding inner passage of sliding sleeve 11 having, for example, an oval cross-section, rod 8 can have, in the area of the rest position of crown member 10 in FIG. 4, a circular, and consequently smaller, cross-section permitting rotation of crown member 10. Sliding sleeve 11 is thus axially blocked in the event of rotation of crown member 10 outside its indexed angular position. The holding of crown member 10 in the safety position, which is angularly offset, can be ensured by a removable pin, by friction, or by elastic cooperation of two opposed relief portions, for example, a ball pressed by a spring in order that an opposed dome of said ball is received in a cavity opposed to said spring.

Alternatively, head 2 comprises a slide member extending over a circumferential sector, rotatable along the axis of rod 8, arranged to lodge in a circumferential groove in crown member 10, and thus lock it in the axial rest position. Crown member 10 is, in such a case, mounted rotationally blocked in relation to rod 8, that is to say angularly indexed, due to the fact that crown member 10 has a specifically adaptated, non circular, shape.

Generally speaking, it will be noted that the technical explanation of the present application is not confined to the problem at the root of the invention, a pod, but applies to any mechanism of the umbrella type, whatever the intended application.

1. Pod for evacuating persons, including a central mast (1, 8), a support section (9) of which bears ends (31) of arms (30) pivotally mounted so that respective opposed free sections (32) are, in a folded back position substantially axial in relation to an axis of the mast (1, 8), maintained by a removable locking device, wherein the locking device comprises an axially movable crown member (10) disposed at an axial distance from the support section (9), to radially maintain the arms (30) locked, the crown member (10) being held in a locking position, through a hysteresis effect, in which the crown member (10) can be driven, through the expansion of a loaded spring (20), one end of which occupies a counter-pressure position axially fixed in relation to the mast (1, 8), in a movement of recoil from its locking position, only after an additional loading of the spring (20) by an external force in order to release a mobile stop (21) arranged for inhibiting the action of the spring (20) and held in a precarious anti-recoil stop equilibrium by the crown member (10).

2. Pod according to claim 1, in which the crown member (10) is mounted for sliding on an opposed section (2) of the mast (1, 8).

3. Pod according to claim 1, in which the crown member (10) is mounted for sliding on a section of a particular one of the arms (30).

4. Pod according to claim 3, in which the spring (20) is arranged so that its counter-pressure is exerted on a lateral relief portion of the particular arm.

5. Pod according to claim 1, in which the stop (21) is arranged to take a counter-pressure on a lateral relief portion of one of the arms (30).

6. Pod according to claim 1, in which there are provided means (22) for driving the stop (20) out of its position of precarious equilibrium.

7. Pod according to claim 6, in which the means for driving the stop (21) comprise a return spring (22).

8. Pod according to claim 6, in which the means for driving the stop (21) comprise a link fixed to the crown member (10).

9. Pod according to claim 6, in which the means for driving the stop (21) comprise (use B)

10. Pod according to claim 1, in which the crown member (10) comprises an axial relief portion (15) for maintaining the stop (21) in precarious equilibrium.

11. Pod according to claim 1, in which the stop (21) is mounted so as to be movable on the mast (1, 8).

12. Pod according to claim 1, in which the stop (1) is mounted so as to be movable on the crown member (10).

13. Pod according to claim 1, in which the stop (21) is mounted pivotally.

14. Pod according to claim 13, in which the stop member (21) is mounted so as to pivot elastically about an axis substantially parallel to a sliding direction of the crown member (10) so as to be drawn back, out of a position of precarious equilibrium, into an angular sector affording it free axial passage.

15. Pod according to claim 13, in which the stop (21) is associated with a pivoting limiting member defining the position of precarious equilibrium, in which the stop (21) is associated with a pivoting limiting member defining the position of precarious equilibrium and in which the stop (21) has a travel intersecting, in the position of precarious equilibrium, that of another stop forming the pivoting limiting member.

16. (canceled)

17. Pod according to claim 1, in which the stop (21) comprises a hook having an inner abutment surface cooperating with a relief portion for retaining the crown member (10).

18. Pod according to claim 1, in which the stop (21) has the shape of a cam arranged for, when located outside the position of precarious equilibrium, being driven by the crown member (10) out of the recoil travel of the latter.

19. Pod according to claim 1, in which the crown member (10) has a determined mass to perform the additional loading of the spring (20) in the event of a threshold of deceleration being exceeded.

20. Pod according to claim 1, in which the crown member (10) is formed by a ring (11) bearing tabs for holding the free sections (32) of the respective arms.

21. Pod according to claim 20, in which the mast (1, 8) is externally threaded over a recoil travel path section on which the crown member (10) recoils, said externally threaded section cooperating with an internal thread of the crown member (10) so as to angularly offset, in the recoil travel movement, sectors, of the tabs, arranged for causing said locking condition, said offset being in relation to fixed sectors occupied by the free sections of the arms.

22. Pod according to claim 1, in which the crown member (10) is arranged to cooperate with a safety mechanism provided for holding it in the position for locking the arms (30).

23. Pod according to claim 22, in which the mast (1, 8) has a non-circular cross-section fitted to a shape corresponding sliding member (11) for an axial sliding of the crown member (10) to angularly index the crown member (10), with the mast (1, 10) having, in the area of the position of the crown member (10) locking the arms (30), a section with a non-fitted cross-section delimiting a circumferential lateral passage accessible to the sliding member (11) through a rotation of the crown member (10) by an operator and having two axially opposed shoulders for holding the crown member (10) in the axial arm locking position.

24. Pod according to claim 22, in which the crown member (10) belongs to a head (2) of the mast (1, 8) comprising a slide means of the safety mechanism, movable in a radial plane of the mast (1, 8) to cooperate with at least one shoulder facing the crown member (10) in order to axially block the crown member (10) in at least one sliding direction.
